(19) United States
(12) Patent Application Publication
(10) Pub. No.: US 2004/0012661 A1
(43) Pub. Date: Jan. 22, 2004

(54) Back pressure regulator for ink-jet pen

(76) Inventors: Chien-Ming Lin, Taipei City (TW); Kun-Lang Yang, Tainan City (TW)

Correspondence Address: BIRCH STEWART KOLASCH & BIRCH, PO BOX 747, FALLS CHURCH, VA, 22040-0747, US

(21) Appl. No.: 10/614,119

(22) Filed: Jul. 8, 2003

(30) Foreign Application Priority Data
Jul. 18, 2002 (TW) 091116095

(51) Int. Cl. B41J 2/19

(52) U.S. Cl. 347/92

(57) ABSTRACT

A back pressure regulator for ink-jet pen, using a cover element and recess in the pen to form a specific gap, to constantly maintains a quantity of ink to form a liquid-air interface, to prevent excess air freely to flow into the ink-jet pen, so as to act as a pressure regulator. The ink-jet pen has an orifice providing a passage in the recess for ambient air to bubble into, to prevent the back pressure from rising above a level that would cause malfunction of the pen. The recess includes at least two grooves which starts from the orifice, and provides a diversity of grooves in opposite or different directions. The grooves further having an inclined or curved bottom surface to define a gap between the cover element and the bottom surface thereof. The gap between the cover element and recess is smallest near the orifice and increases as the distance from the orifice increases. This geometry, helps to induce the bubble efficiently moving along the grooves and finally bubbles into the pen through an opening of the cover element, and is capable of constantly urges a quantity of ink toward the orifice at the smallest portion of the gap, and to seal the orifice to maintain the back pressure above a level in the pen.

### FIELD OF THE INVENTION

This invention relates back pressure regulator for ink-jet pen, and more particularly, to a back pressure regulator using a gap for maintaining ink to seal a vent orifice of the pen so as to maintain the back pressure therein above a desirable level.

### BACKGROUND OF THE INVENTION

Generally, an ideal back pressure regulators for an ink-jet pen shall include at least the following properties:

1. the back pressure regulator can precisely control and maintain a sufficient negative pressure in the ink-jet pen;

2. while the ambient air bubbles into the ink-jet pen, the pressure regulator can soon to generate an air-liquid interface to seal the flowing path, so as maintaining a back pressure at a predetermined level in the ink-jet pen; and

3. the ink in the back pressure regulator having an adhesive force on the surface which larger than the cohesive force of the ink, so as building a steady status of an air-liquid interface for sealing the ambient air from freely bubbles into the pen, notwithstanding the depletion of ink, pen inclined or inverted, or the ink no longer cover the pressure regulator.

Related art to regulate the back pressure for ink-jet pen, such as U.S. Pat. No. 5,988,806, described a valve, incorporated with the top of an ink-jet pen, having a labyrinth such as twisted passage path through which ambient air must travel before entering the separator chamber via a port, in which, a steel ball is concentrically maintained by a number of raised crush ribs, wherein the gaps between the ribs and exterior surface of the steel ball allowing ambient air to travel therethrough, however, it also constantly urges a trapped quantity of ink to form as a liquid-air interface. In this manner, to prevent the excess air freely to flow into the ink-jet pen, and act as a pressure regulator.

In U.S. Pat. No. 5,526,030, the back pressure of ink pen is maintained by providing a capillary member adjacent to a bubble generator. At the proximal end of the capillary member precisely fitted a sphere. As the back pressure returns to a desirable level, ink will trapped by the capillary member enters the orifice to reseal the orifice. The structure illustrated hereof needs high precision molding apparatus, material and strict manufacturing process control, therefore it is difficult in maintaining a good yield rate of the product; any poor quality may cause malfunction in its pressure regulation.

U.S. Pat. No. 5,363,130, discloses a valve using a similar back pressure regulation approach, provided a valve for air bubbles through a labyrinth and the valve and into the pen. In view of the structure contains many parts that are meticulous and complex, that would causes higher cost and needs more expensive instruments for its assembly.

Related art using valve element to control the back pressure in in-jet pen, as disclosed in U.S. Pat. No. 5,341,160, the valve includes a sealing liquid and vent tube, to function as back pressure controller in in-jet pen. However, there are still using too many elements to construct the back pressure, therefore the product assembly lines needs higher precise instrument to aid, therefore, the cost would be high.

In view of the approaches of above related arts are relatively complex, multi-pieces structure which do not lend themselves to mass production at reasonable low cost; therefore, there is a longstanding technical needed to simplify the elements, improve the convenience for fabrication of an in-jet pen in a good product yield ratio.

### SUMMARY OF THE INVENTION

The objective of the present invention is to simplify the structure of the back pressure regulator for an ink-jet pen, using only a single part to combine with a recess to form a specific gap. Due to the ink having an adhesive force varying along the different portion of the gap, once the ambient air bubbles into the pen, the gap will constantly urges the air moving into the pen, and traps a quantity of ink to form a liquid-air interface to reseal the passage of air flow. In this manner, to maintain the back pressure above a level in the pen.

In accordance with the present invention, an embodiment of the pressure regulator for ink-jet pen, using a cover element and recess in the pen to form a specific gap, to constantly maintains a quantity of ink to form a liquid-air interface, to prevent excess air freely to flow into the ink-jet pen, so as to act as a pressure regulator. The ink-jet pen has an orifice providing a passage in the recess for ambient air to bubble into, to prevent the back pressure from rising above a level that would cause malfunction of the pen. The recess includes at least two grooves which starts from the orifice, and provides a diversity of grooves in opposite or different directions. The grooves further having an inclined or curved bottom surface to define a gap between the cover element and the bottom surface thereof. The gap between the cover element and recess is smallest near the orifice and increases as the distance from the orifice increases. This geometry, helps to induce the bubble efficiently moving along the grooves and finally bubbles into the pen through an opening of the cover element, and is capable of constantly urges a quantity of ink toward the orifice at the smallest portion of the gap, and to seal the orifice to maintain the back pressure above a level in the pen.

According to the present invention, alternative embodiment of the cover element may be formed as a spiral element with spiral gaps thereof, so as to allow air bubble passing through and urges a quantity of ink toward the orifice quickly, to seal the orifice and maintain the back pressure above a level in the pen.

Other objects, features and advantages of the present invention will become apparent upon consideration of the following detailed description and the accompanying drawings, in which like reference designations represent like features throughout the FIGURES.

### DESCRIPTION OF THE DRAWINGS

FIG. 1 is a perspective view showing an ink-jet pen.

FIG. 2 is a simplified view in section showing a recess in the pen defining a specific gap between a cover element and the bottom surface thereof, allowing ambient air to bubble into the pen from an orifice and urging a quantity of ink toward the orifice quickly, to seal the orifice and maintain the back pressure above a level in the pen.

FIG. 3 is a partial top plan view showing a first embodiment according to the present invention.

FIG. 4 is a partial cross-sectional view showing a first embodiment according to the present invention.

FIG. 5 is a partial cross-sectional view showing a second embodiment according to the present invention.

FIG. 6 is a partial cross-sectional view showing a third embodiment according to the present invention.

The drawings should be understood as not being to scale except where specially noted.

### DETAILED DESCRIPTION OF THE INVENTION

Ink in a small gap, the boundary is a main factor for controlling its flowing mode therein. However, when ink comes to a standstill, the figure of free liquid boundary shall be determined by both of the surface tension force and the drag force on the boundary. Therefore, providing a suitable gap for an ink flow, shall determine the final balanced air-liquid interface

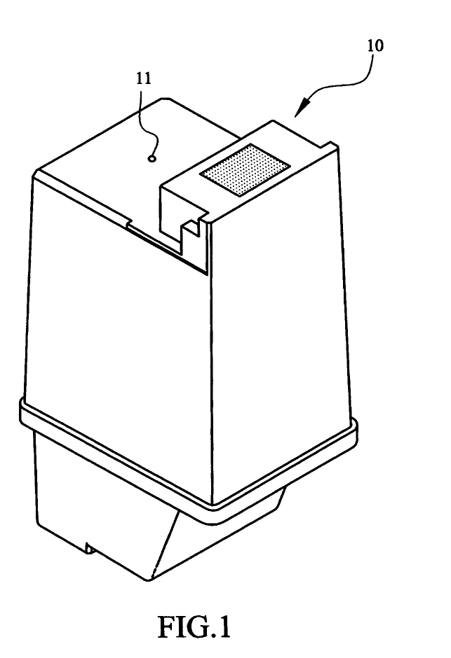

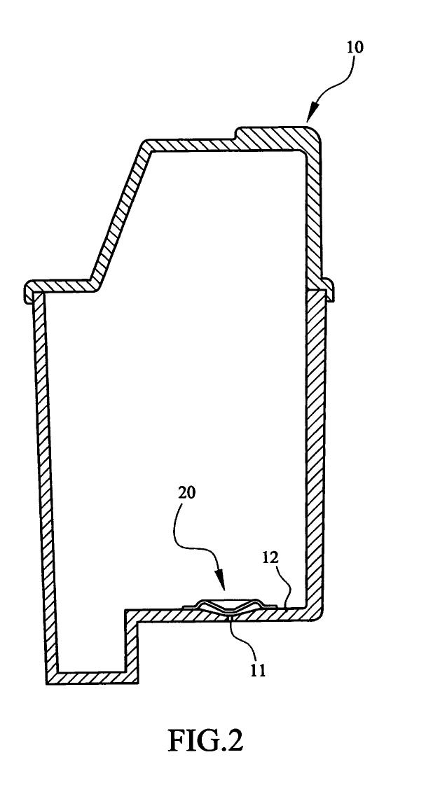

Referring to FIGS. 1 and 2, the wall (12) of ink-jet pen (10) has an orifice formed therein for providing a orifice(11) of air, from which allowing the ambient air to bubble into therethrough, so as to prevent the back pressure from rising above a lever that would cause a malfunction of the pen. In accordance with the embodiment of the present invention, a pressure regulator(20) is positioning on the inner side of wall (12), providing suitable gap thereby to induce the ink flow to refill and drags the ink for recovering the air-liquid interface while the balance therein has been disturbed. Once the back pressure has gained to a desirable level and cause the ambient air bubbles into the pen(10) via orifice(11), the gap in accordance with the present invention provides an adhesive force to drag adjacent ink to reseal the orifice(11) while the back pressure in the pen(10) returns to a desirable point.

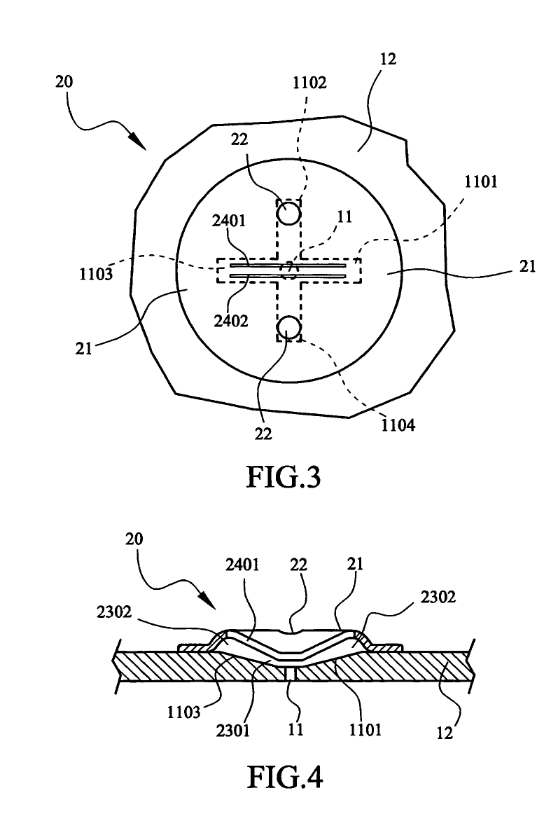

As shown in FIGS. 3, and 4, a back pressure regulator(20) according to the first embodiment of the present invention, may including a orifice(11), a plurality of grooves(1101, 1102, 1103 and 1104) and a cover plate(21). The orifice(11) formed in the wall(12) of the pen(10) providing a vent passage therethrough. On the inner side of the wall(12), the grooves(1101, 1102, 1103 and 1104) which is formed start from the orifice (11) in a diversity of directions.

The cover plate(21) having at least an opening(22) within the area of grooves(1101, 1102, 1103 and 1104) to allows the bubble from orifice(11) to pass through and enter into the pen(10). The bottom of the grooves(1101, 1102, 1103 and 1104) having a rising or depressing shape for forming the gaps between the surface thereof and cover plate(21). Preferably, to form a smallest gap(2301) between cover plate(21) and grooves(1101, 1102, 1103 and 1104) near the orifice(11) and to form a larger gap(2301) increases as the distance from the orifice increases, and thereby providing a stronger adhesive force to the ink around the orifice(11), so as to drag back the ink as been pushed away by the bubble from orifice(11). The cover plate(21) further having a ink supply channels(2401 and 2402) for supplying ink into the grooves(1101, 1102, 1103 and 1104). While the bubble from orifice(11) expel a volume of ink out through the gap(2301 and/or 2302) left the opening(22) into the pen, a volume the ink above the cover plate(21) shall refill the volume in a shortest path and high efficient way via the ink supply channels(2401 and 2402).

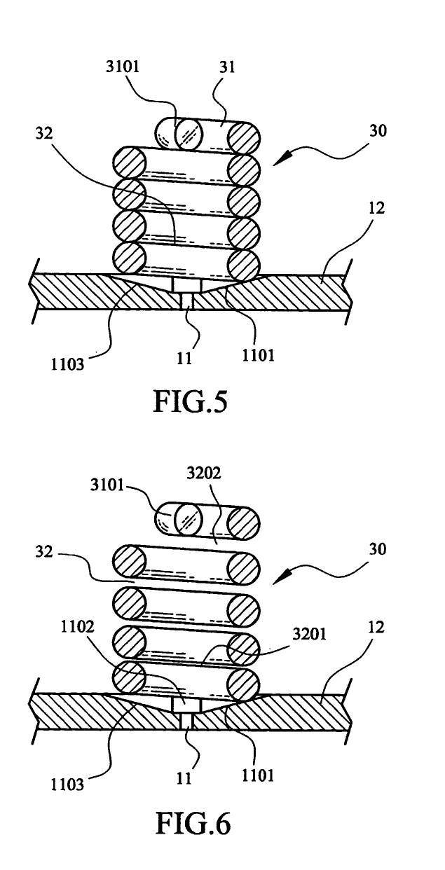

FIG. 5 is a second embodiment of the present invention, a pressure regulator(30) according to the first embodiment of the present invention, may including an orifice(11), a plurality of grooves(1101, 1102, 1103 and 1104) and a cover element(31) in a spiral shape. The cover element (31) may made from metal, plastic, rubber or a similar hydrophilic material to form a spiral gap. The cover element (31) positioned on above the grooves(1101, 1102, 1103 and 1104). For instance, the cover element (31) may formed by a metal coil, in which the upper end portion(3101) of the cover element (31) having a folding portion inwardly fold to the center thereof, so as to reduce the opening at the end and providing an adhesive force to drag the ink, as in the same principle of the first embodiment.

As illustrated in FIG. 6, an alternative modification of a cover element(31) in accordance with the second embodiment, can be formed in a spiral shape with small gap(3201) at one end and larger gap(3203) at another end, so as to provide an adhesive force to drag the ink, in the same principle illustrated in the first embodiment.

In accordance with the present invention, the back pressure regulator for ink-jet pen is simplified and be more easy to manufacture and assemble its embodiment. While the ambient air is bubbled into the gap through the orifice, the gap will constantly urges a trapped quantity of ink to seal the orifice, so as to maintain the back pressure above a predetermined level.

It will be understood by those skilled in the art that the present invention is not limited to the particular embodiment illustrated above. For example, the orifice can further connect to a traditional labyrinth(not shown) to prevent the entrapped ink in the pressure regulator from drying or solidifying as a result of prolonged exposure to the atmosphere. Apparently, having described and illustrated the principles of the invention with reference to preferred embodiments, it should be apparent that the invention can be further modified in arrangement and detail without departing from such principles.

The embodiments discussed above are intended to demonstrate the various advantages features of the present invention, but those killed in the art will understand that the invention is not limited to these particular features. Those skilled in the art will understand that other modification, deletion and adaptations can be made to the embodiments discussed above which are all within the scope and spirit of the following claims and the equivalents thereof.

What is claimed is:

1. a back pressure regulator for ink-jet pen, comprising
an orifice formed as a passage in the wall of the ink-jet pen for allowing an ambient air to bubble into the pen;
a recess formed on the inner side of the wall, and capable of communicate with the ambient air via the orifice; and
a cover element positioning above the recess, having ink supply channel for providing a shortest path to supply the ink to the recess in a high efficient way, and an opening within the area of the recess for allowing the air bubbles enter into the pen.

2. The back pressure regulator of claim 1, wherein the recess having at least two grooves which starts from the end of the orifice and extending to different directionss on the wall of the ink-jet pen.

3. The back pressure regulator of claim 2, wherein the recess having three grooves which starts from the end of the orifice and extending to different directions on the wall of the ink-jet pen to form as a “Y” shape.

4. The back pressure regulator of claim 2, wherein the recess having four grooves which starts from the end of the orifice and extending to different directions on the wall of the ink-jet pen to form as a “+” shape.

5. The back pressure regulator of claim 2, wherein the recess having bottom surface varying in depth thereof for defining a varying gap between the cover element and the bottom surface.

6. The back pressure regulator of claim 5, wherein the gap having a smallest portion near the orifice and a larger portion increases as the distance from the orifice increases, and thereby providing a stronger adhesive force to the ink around the orifice.

7. The back pressure regulator of claim 1, wherein the recess having bottom surface varying in depth thereof for defining a varying gap between the cover element and the bottom surface.

8. The back pressure regulator of claim 7, wherein the gap having a smallest portion near the orifice and a larger portion increases as the distance from the orifice increases, and thereby providing a stronger adhesive force to the ink around the orifice.

9. The back pressure regulator of claim 1, wherein the cover element is made form metal, plastic rubber or similar hydrophilic material.

10. a back pressure regulator for ink-jet pen, comprising
an orifice formed as a passage in the wall of the ink-jet pen for allowing ambient air to bubble into the pen;
a recess formed on the inner side of the wall, and capable of communicate with the ambient air via the passage; and
a cover element form in spiral shape and positioning above the recess, having a spiral gap providing an ink supply channel and an opening within the area of the recess for allowing the air bubbles enter the pen.

11. The back pressure regulator of claim 10, wherein the recess having at least two grooves which starts from the end of the orifice and extending to different directions on the wall of the ink-jet pen.

12. The back pressure regulator of claim 11, wherein the recess having three grooves which starts from the end of the orifice and extending to different directions on the wall of the ink-jet pen to form as a “Y” shape.

13. The back pressure regulator of claim 11, wherein the recess having four grooves which starts from the end of the orifice and extending to different directions on the wall of the ink-jet pen to form as a “+” shape.

14. The back pressure regulator of claim 10, wherein the cover element having a spiral gap, the gap having a smallest portion near the orifice and a larger portion increases as the distance from the orifice increases, and thereby providing a stronger adhesive force to the ink around the orifice.

15. The back pressure regulator of claim 10, wherein the cover element is formed in a coil shape by winding of a metal wire.
